(19) United States
(12) Patent Application Publication
(10) Pub. No.: US 2009/0044515 A1
(43) Pub. Date: Feb. 19, 2009

(54) SYSTEM AND METHOD FOR REMOVING PARTICULATE MATTER FROM A DIESEL PARTICULATE FILTER

(76) Inventors: SHUGUANG LU, Troy, MI (US); ERIC RICHARD DILLEN, Edinboro, PA (US); SHAWN MICHAEL GALLAGHER, Erie, PA (US)

Correspondence Address: BEUSSE WOLTER SANKS MORA & MAIRE, P.A., 390 NORTH ORANGE AVENUE, SUITE 2500, ORLANDO, FL, 32801, US

(21) Appl. No.: 11/838,277

(22) Filed: Aug. 14, 2007

(51) Int. Cl. F01N 3/023; G06F 17/00

(52) U.S. Cl. 60/277; 60/274; 700/90

(57) ABSTRACT

A system is provided for removing particulate matter from a diesel particulate filter. The diesel particulate filter includes at least one diesel particulate filter unit to filter particulate matter from diesel engine exhaust gas received from a diesel engine. The system includes a sensor positioned adjacent to at least one diesel particulate filter unit, where the sensor is configured to determine the extent of particulate matter trapped within the diesel particulate filter unit. The system further includes an engine controller coupled to the sensor and the diesel engine, where the sensor is configured to output a first alert signal to the engine controller upon determining that the trapped particulate matter exceeds a predetermined threshold. The engine controller is configured to increase the temperature of the diesel exhaust gas entering the diesel particulate filter upon receiving the first alert signal.

This application is related to U.S. patent application Ser. Nos. ______ (Attorney Docket No. 226403-1 (592) and ______ (Attorney Docket No. 226266-1 (593), filed concurrently herewith. Each of the foregoing applications is incorporated by reference herein in their entirety.

### FIELD OF THE INVENTION

This invention relates to aftertreatment systems, such as diesel particulate filters, and more particularly to a system and method for removing particulate matter from a diesel particulate filter.

### BACKGROUND OF THE INVENTION

Diesel engines have been extensively used in various applications, such as locomotives, for example. Diesel engine exhaust gas is typically outputted from the engine (or a turbocharger connected to the diesel engine) and directed to an output, such as to the atmosphere for a locomotive diesel engine, for example.

More stringent emissions standards on diesel engines have led to the introduction of aftertreatment systems to reduce emissions. Particulate matter is one such emissions constituent that is being more aggressively regulated. The most strict particulate standards have led to the use of particulate trapping devices in the exhaust systems. These devices act like a filter to capture particulate matter in the exhaust.

After a prolonged period of operating time, the diesel particulate filter of the conventional system will become backlogged with excessive trapped particulate matter. This trapped particulate matter may be removed from the diesel particulate filter using various techniques, such as regeneration, for example. Regeneration is a technique used to clean particulate filters onboard the vehicle, when the filter has captured enough soot particles to restrict flow below an acceptable level. Regeneration is accomplished by increasing the temperature of the particulate filter, so the soot particles are oxidized. The regeneration process removes the carbon particles, leaving only a minor amount of ash. The accumulated ash eventually needs removed, but this is usually done during a scheduled maintenance. In order for the regeneration to happen, a control system needs to be employed to monitor the amount of particulate matters in the particulate filter, to determine the regeneration timing and raise the engine gas temperature to a certain level.

Accordingly, it would be advantageous to provide a system to remove the trapped particulate matter from the diesel particulate filter and other aftertreatment systems, to improve the flow rate of diesel exhaust gas from the diesel engine and the overall efficiency of the diesel engine.

### BRIEF DESCRIPTION OF THE INVENTION

One embodiment of the present invention provides a system for removing particulate matter from a diesel particulate filter. The diesel particulate filter includes at least one particulate filter unit to filter the particulate matter from diesel engine exhaust gas received from a diesel engine. The system includes at least one sensor positioned adjacent to at least one diesel particulate filter unit, where the at least one sensor is configured to determine the extent of particulate matter trapped within the diesel particulate filter unit. The system further includes an engine controller coupled to the at least one sensor and the diesel engine. Each sensor is configured to output a first alert signal to the engine controller upon determining that the trapped particulate matter within the diesel particulate filter unit exceeds a predetermined threshold. The engine controller is configured to increase the temperature of the diesel exhaust gas entering the diesel particulate filter upon receiving the first alert signal.

Another embodiment of the present invention provides a method for removing particulate matter from a diesel particulate filter. The diesel particulate filter includes at least one diesel particulate filter unit to filter the particulate matter from diesel engine exhaust gas received from a diesel engine. The method includes determining the extent of particulate matter trapped within the diesel particulate filter unit by positioning at least one sensor adjacent to at least one diesel particulate filter unit. The method further includes configuring each sensor to output a first alert signal to an engine controller upon determining that the trapped particulate matter within the diesel particulate filter unit exceeds a predetermined threshold. Additionally, the method includes configuring the engine controller to increase the temperature of the diesel exhaust gas entering the diesel particulate filter upon receiving the first alert signal.

Another embodiment of the present invention provides a system for removing particulate matter from a particulate filter. The particulate filter includes at least one particulate filter unit to filter the particulate matter from engine exhaust gas received from an internal combustion engine. The system includes an engine controller coupled to the engine, where the engine controller includes a memory configured to store at least one loading rate of the diesel particulate filter over a distance or time increment of the locomotive traveling along a route. Once the engine controller determines that a level of trapped particulate matter within the diesel particulate filter exceeds a predetermined threshold, the engine controller is configured to increase the temperature of the exhaust gas entering the particulate filter. The engine controller is configured to calculate the level of trapped particulate matter based upon an initial level of trapped particulate matter and at least one loading rate at each distance or time increment.

Another embodiment of the present invention provides computer readable media containing program instructions for removing particulate matter from a diesel particulate filter. The diesel particulate filter includes at least one diesel particulate filter unit to filter the particulate matter from diesel engine exhaust gas received from a diesel engine. The computer readable media includes a computer program code to configure the engine controller to increase the temperature of the diesel exhaust gas entering the diesel particulate filter upon receiving the first alert signal.

### BRIEF DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 depicts a schematic side view of an exemplary embodiment of a system for reducing particulate matter emission in engine exhaust gas;

FIG. 2 depicts a schematic end view of an exemplary embodiment of a system for reducing particulate matter emission in engine exhaust gas;

FIG. 3 depicts an isolated perspective view of an exemplary embodiment of a diesel particulate filter among a system for removing particulate matter from a diesel particulate filter in accordance with the present invention;

FIG. 4 depicts an isolated perspective view of an exemplary embodiment of a diesel engine among a system for removing particulate matter from a diesel particulate filter in accordance with the present invention;

FIG. 5 depicts a schematic side view of an exemplary embodiment of a system for removing particulate matter from a diesel particulate filter in accordance with the present invention;

FIG. 6 depicts a schematic side view of an exemplary embodiment of a system for removing particulate matter from a diesel particulate filter in accordance with the present invention;

FIG. 7 depicts a schematic side view of an exemplary embodiment of a system for removing particulate matter from a diesel particulate filter in accordance with the present invention; and

FIG. 8 depicts an exemplary embodiment of a method for removing particulate matter from a diesel particulate filter in accordance with the present invention.

### DETAILED DESCRIPTION OF THE INVENTION

Reference will now be made in detail to the embodiments consistent with the invention, examples of which are illustrated in the accompanying drawings. Wherever possible, the same reference numerals used throughout the drawings refer to the same or like parts.

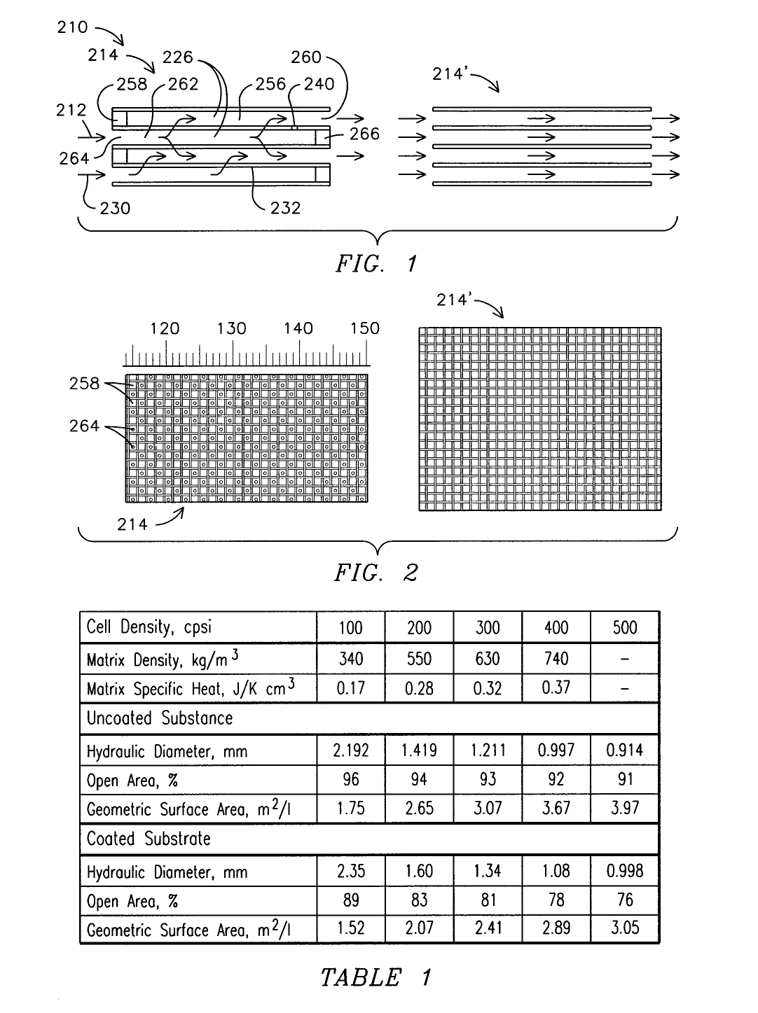

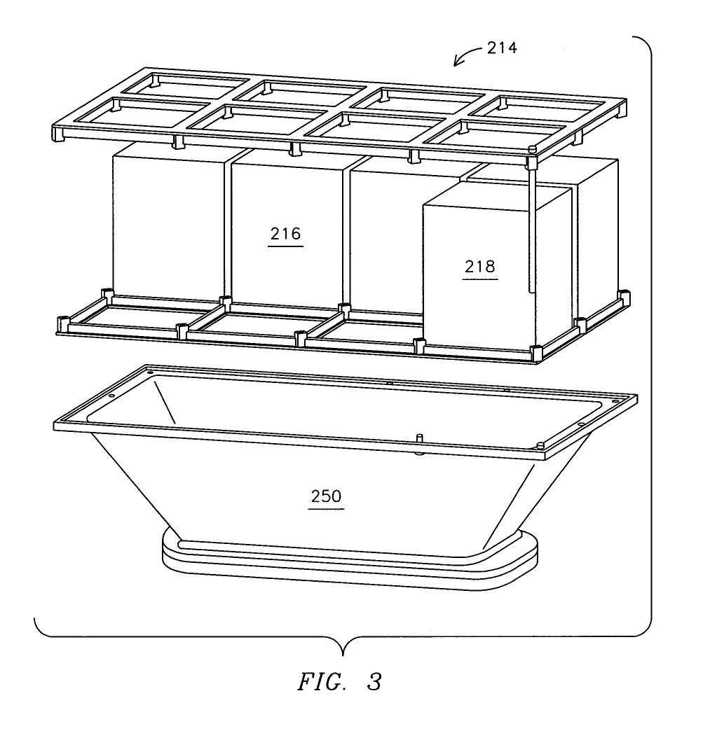

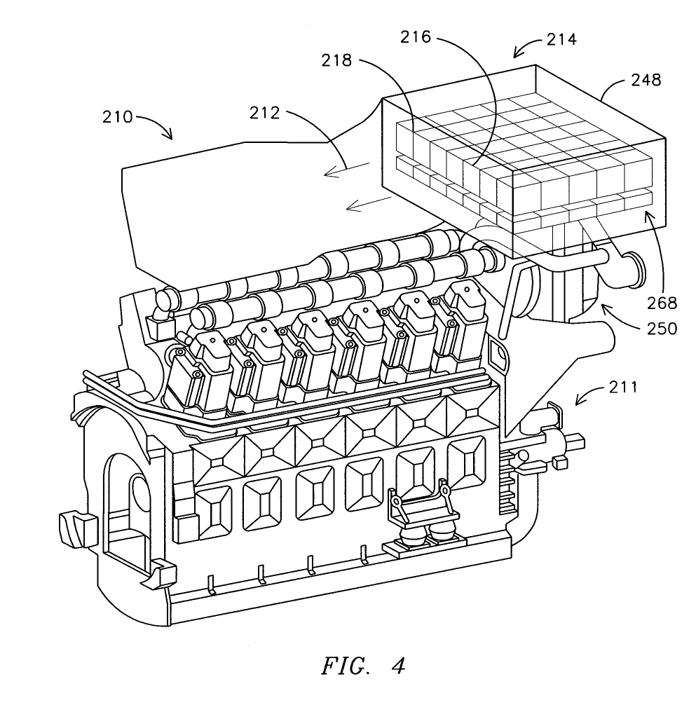

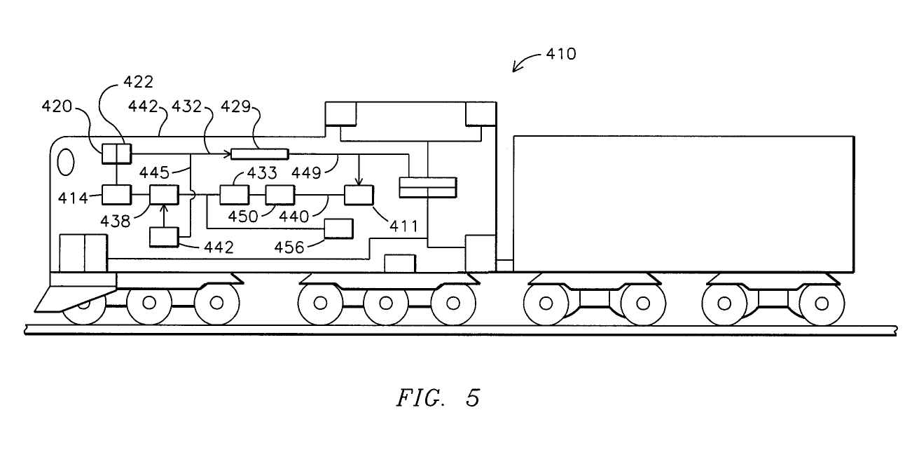

FIGS. 1 and 2 illustrate exemplary embodiments of a wall-flow diesel particulate filter 214 and a flow-through diesel particulate filter 214′. The diesel particulate filter 214 illustrated in the exemplary embodiment of FIGS. 1 and 2 is an example of an aftertreatment system, and similar examples may be constructed for wall-flow diesel particulate filters, to chemically reduce any or all species in the diesel engine exhaust, such as hydrocarbons, CO, nitrous dioxide, and other chemicals appreciated by one of skill in the art, as further discussed below in additional embodiments of the present invention. As illustrated in FIG. 1, a diesel particulate filter unit 216 (illustrated in FIGS. 3 and 4) includes a plurality of channels 226 aligned in a flow direction 230 of the diesel engine exhaust gas 212. The channels 226 of each diesel particulate filter unit 216 are selectively configured with a distinct cross-sectional area density. Thus, the cross-sectional area density of the channels of the center diesel particulate filter 216 may be greater than the cross-sectional area density of the channels of the outer diesel particulate filter 218 (illustrated in FIGS. 3 and 4). The cross-sectional area density of a diesel particulate filter unit may be directly proportional to its resistance to a cross-sectional region of diesel exhaust gas. However, the cross-sectional area density of the channels may be the same for different diesel particulate filter units, or may be non-uniform across a diesel particulate filter unit.

As further illustrated in the exemplary embodiment of FIG. 1, a plurality of walls 232 are positioned to separate adjacent channels 226 of the diesel particulate filter unit 216. The walls 232 of the diesel particulate filter unit 216 are designed with a respective thickness. The wall thickness of the center diesel particulate filter unit 216 is greater than the wall thickness of the outer diesel particulate filter unit 218. The respective wall thickness of a diesel particulate filter unit may be directly proportional to its resistance to a cross-sectional region of diesel exhaust gas. However, the wall thickness may be the same for different diesel particulate filter units, or may be non-uniform across a diesel particulate filter unit.

As further illustrated in FIG. 1, a plurality of pores 240 are positioned within the plurality of walls 232, and the pores 240 are configured to vacate a distinct ratio of the area of the walls 232. The pores ratio of the walls of the center diesel particulate filter 216 may be lower than the pores ratio of the walls of the outer diesel particulate filter 218 The pores ratio of the walls of a diesel particulate filter may be inversely proportional to its resistance to a cross-sectional region of diesel exhaust gas. However, the pores ratio may be the same for different diesel particulate filter units, or may be non-uniform across a diesel particulate filter unit.

As further illustrated in FIGS. 1 and 2, the plurality of channels 226 of the diesel particulate filter unit 216 include a plurality of first channels 256 with a blocked inlet 258 and an open outlet 260. Additionally, the plurality of channels 226 include a plurality of second channels 262 with an open inlet 264 and a blocked outlet 266. Each first channel 256 is positioned adjacent to a second channel 262, and each second channel 262 is positioned adjacent to a first channel 256. Although the first channel and second channel are illustrated in FIG. 1 with alternating blocked inlet/open inlet and blocked outlet/open outlet, each diesel particulate filter unit may include one or more channels with a blocked/open inlet and blocked/open outlet which is out of sequence with its adjacent channels.

During operation of the system 210, upon a respective cross-sectional region of the diesel exhaust gas 212 entering a second channel 262 of a diesel particular filter unit 216, the diesel exhaust gas is configured to pass through one of the walls 232 separating the plurality of first channels 256 and plurality of second channels 262. The diesel exhaust gas 212 subsequently passes into a first channel 256 and exits through the open outlet 260 of the first channel 256 to the atmosphere. However, various other paths may be taken by the diesel exhaust gas 212 through the diesel particulate filter 216. Upon the diesel exhaust gas 212 passing from the second channel 262, through the wall 232 and into the first channel 256, particulate matter of the diesel exhaust gas 212 is trapped within the pores 240 of the wall.

In designing each diesel particulate filter unit 216,218, the selective cross-sectional area density of the plurality of channels, the respective wall thickness and the ratio of pores within the walls is selectively determined based upon a flow rate of the respective cross-sectional region of the diesel exhaust gas 212 which is expected to pass over the respective diesel particulate filter unit 216,218. The plurality of diesel particulate filter units 216,218 may be comprised of silicon carbide, cordierite material, or any other material, or combination of materials appreciated by one of skill in the art.

As illustrated in FIG. 4, the diesel particulate filter 214 may include a diesel particulate filter housing 248 for the plurality of diesel particulate filter units 216,218. As further illustrated in FIG. 4, the diesel engine exhaust gas 212 is output from a locomotive diesel engine 211 into a turbocharger 250 and subsequently from a turbocharger outlet into the diesel particulate filter 214. As further illustrated in FIG. 4, the system 210 may include a catalyst device 268 positioned between the turbocharger 250 and the diesel particulate filter 214, to receive the diesel engine exhaust gas 212 output from the turbocharger. The catalyst device 268 is configured to increase the temperature of the diesel engine exhaust gas 212 directed into the diesel particulate filter 214, and may be contained within the housing 248.

Although the embodiment of the system 210 to reduce particulate matter emission in diesel engine exhaust gas 212 involves the use of a diesel particulate filter 214, various other aftertreatment systems may be utilized to control the distribution of exhaust flow over the cross section of the flow path by using aftertreatment substrates with different flow characteristics at the various locations across the channel. The embodiments of the present invention all include aftertreatment systems which may be used to alter the flow characteristic over the cross-section using a number of techniques. As described in the system 210 above, varying the cross-sectional area density and/or wall thickness of a wall-flow particulate filter (i.e., a particulate filter with alternating blocked inlet-open outlet channels, and open inlet-blocked outlet channels) is one example of such an aftertreatment system. However, another exemplary embodiment of the present invention involves an aftertreatment system to combine a wall-flow particulate filter 214, as illustrated in FIGS. 1 and 2, with a flow-through particulate filter 214′ (i.e., a diesel particulate filter with an open inlet-open outlet channel arrangement), also illustrated in FIGS. 1 and 2 to get a favorable flow and thermal characteristic. Additionally, in an additional exemplary embodiment of the present invention, the materials of the flow-through particulate filters 214′ or the wall-flow particulate filters 214 may be combined in such a fashion to get such favorable flow and thermal characteristics, and such materials may include silicon carbide, cordierite, mullite, or metal mesh, among others.

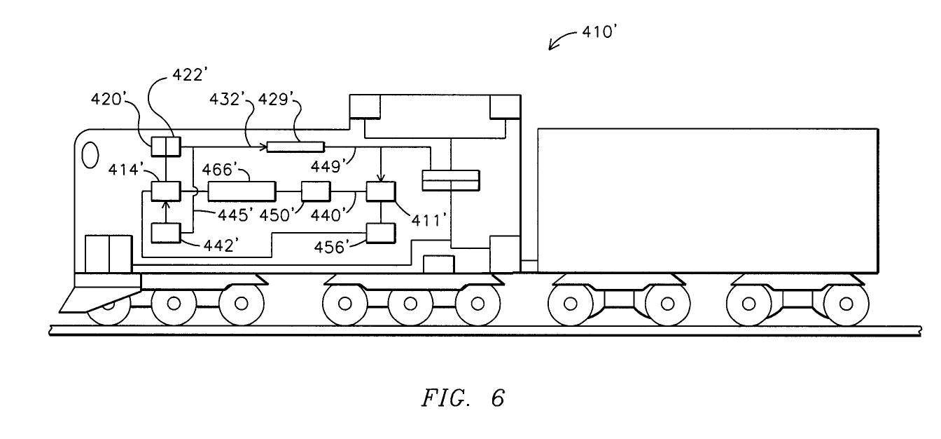

FIG. 5 illustrates a system 410 to remove particulate matter from a diesel particulate filter 414. Although FIG. 5 illustrates the system 410 employed on a locomotive 441, and coupled to a locomotive diesel engine 411, the system 410 may be utilized with vehicles other than locomotives, such as marine vehicles and off-highway vehicles, for example. Although the system 410 may be utilized to remove particulate matter from a diesel particulate filter 414 while a locomotive 441 is in motion, it also is capable of performing such removal (ie. regeneration) independent of the locomotive motion, while the locomotive is stationary.

The diesel particulate filter 414 includes a plurality of diesel particulate filter units to filter the particulate matter from diesel engine exhaust gas received from a diesel engine 411. The diesel particulate filter 414 includes the plurality of diesel particulate filter units is described above in the previous embodiments. As illustrated in FIG. 5, the system 410 includes a pair of sensors 420,422 positioned adjacent to the diesel particulate filter 414 including one or more diesel particulate filter units. The sensors 420,422 are configured to determine the extent of particulate matter trapped within the diesel particulate filter 414. Although FIG. 5 illustrates a pair of sensors positioned adjacent to the diesel particulate filter, one sensor or more than two sensors may be so positioned.

The system 410 further includes an engine controller 429 coupled to the sensors 420,422 and the diesel engine 411. The sensors 420,422 are configured to output a first alert signal 432 to the engine controller 429 upon determining that the trapped particulate matter within the diesel particulate filter 414 exceeds a predetermined threshold. The predetermined threshold may be preset by the user prior to operation of the system 410. In an exemplary embodiment of the system, the predetermined threshold may be determined by a sensor for an equivalent to trapped particulate matter encompassing 50% of the allowable space within the diesel particulate filter, for example. As discussed below, the predetermined threshold is based upon several factors, including the conditions under which the trapped particulate matter will be removed, including temperature, duration of the removal process, use of assisting components, etc. The engine controller 429 is configured to increase the temperature of the diesel exhaust gas entering the diesel particulate filter 414 upon receiving the first alert signal 432.

In one embodiment of the system 410, the system further includes a turbocharger 450 including an exhaust manifold to receive the diesel engine exhaust gas from the diesel engine 411 and further including an outlet to output the diesel exhaust gas to the diesel particulate filter 414. The system 410 further includes an injector device 433 positioned between the turbocharger 450 and the diesel particulate filter 414, where the injector device is configured to selectively inject an adjustable amount of diesel fuel into the diesel engine exhaust gas exiting the outlet. Additionally, the system 410 further includes a reactive device 438 positioned between the injector device 434 and the diesel particulate filter 414. The reactive device 438 is configured to selectively ignite the adjustable amount of injected diesel fuel within the diesel engine exhaust gas upon entering an inlet of the reactive device 438 to increase the temperature of the diesel exhaust gas entering the diesel particulate filter 414. Various reactive devices may be used, such as catalyst devices, fuel burners, and any other devices appreciated by one of skill in the art.

As further illustrated in FIG. 5, the embodiment of the system 410 includes a temperature sensor 442 coupled to the engine controller 429 and positioned adjacent to the reactive device 438. The temperature sensor 442 is configured to determine the temperature of the diesel engine exhaust gas entering the reactive device 438. The temperature sensor 442 is further configured to transmit a second alert signal 445 to the engine controller 429 upon measuring a temperature lower than a first minimum threshold for the reactive device 438 to ignite the diesel fuel. The first minimum threshold depends on various factors, including the type of reactive device, including its material components, method of reacting with the fuel, ambient temperature, and other factors to determine the minimum temperature at which the reactive device will ignite the diesel fuel, thereby increasing the temperature of the diesel exhaust gas containing the ignited diesel fuel. In an exemplary embodiment of the system 410, the first minimum threshold is approximately 200 degrees Celsius, and the temperature of the diesel engine exhaust gas is lower than the first minimum threshold when the locomotive diesel engine 411 is in an idle state. However, the first minimum threshold may be any particular value consistent with a minimum temperature at which the reactive device ignites injected diesel fuel within the diesel exhaust gas.

The engine controller 429 is configured to increase the temperature of the diesel exhaust gas entering the reactive device 438 to greater than the first minimum threshold after the engine controller 429 has received the first alert signal 432 and the second alert signal 445. Thus, the engine controller 429 provides an initial increase in the temperature of the diesel exhaust gas, to the first minimum threshold, to enable a subsequent increase in the temperature of the diesel exhaust gas via ignition of the injected diesel fuel by the reactive device 438.

To initially increase the temperature of the diesel exhaust gas, the engine controller 429 may increase the temperature through a number of methods. For example, the engine controller 429 is configured to transmit an increase signal 449 to the diesel engine 411 to increase an artificial load on the diesel engine, and thereby cause an increase in the temperature of the diesel engine exhaust gas entering the reactive device 438. Alternatively, the increase signal 449 may change the speed of the engine 411, to cause an increase in the temperature of the diesel engine exhaust gas entering the reactive device 438. Thus, upon the artificial load being placed on the diesel engine 411, an increased temperature diesel exhaust gas would be expelled from the diesel engine 411, and passed through the turbocharger 450 and injector 434 to the reactive device 438. Alternatively, the engine controller 429 may be configured to electrically couple an alternator 456 of the diesel engine 411 to the turbocharger outlet 440 to cause an increase in the temperature of the diesel engine exhaust gas entering the reactive device 438. Alternatively, in an exemplary embodiment of the system 410, the alternator 456 may be coupled to the diesel particulate filter 414, and electrically heat the diesel particulate filter, for example. The engine controller 429 may be also configured to transmit a signal to the engine 411 to change a fuel injection schedule, so to cause an increase in the temperature of said engine exhaust gas entering the reactive device 438.

In an embodiment of the system 410, the engine controller 429 transmits an increase signal to the engine 411, and the temperature sensor 442 is configured to transmit an overheat signal to the engine controller 429 upon measuring the temperature of the engine exhaust gas exiting the particulate filter 414 exceeding an overheat threshold. In this embodiment, the engine controller 429 is configured to cause the engine 411 to increase the airflow through the particulate filter 414 upon receiving the overheat signal. By increasing the airflow through the particulate filter 414 when the temperature of exiting engine exhaust gas is above an overheat threshold, the temperature will decrease below this overheat threshold, and minimize the probability of damage to the particulate filter 414.

As discussed in the previous embodiments of the present invention and illustrated in FIG. 1, each diesel particulate filter unit 216,218 of the diesel particulate filter 414 includes a plurality of channels 226 oriented parallel with the flow direction 230 of the diesel engine exhaust. The pair of sensors 420,422 is a pair of pressure sensors 420,422 positioned on opposing sides of the plurality of channels 226 of the diesel particulate filter unit 216 (FIG. 1). The pressure sensors 420,422 are configured to transmit the first alert signal 432 to the engine controller 429 upon measuring a pressure difference across the plurality of channels 226 exceeding a predetermined pressure threshold. As the trapped particulate matter accumulates within the walls of the diesel particulate filter, as discussed in the previous embodiments, the pressure difference across a channel 226, as measured by the pressures sensors 420,422, increases. The predetermined pressure threshold may be selectively determined based upon a number of factors, including, for example, the time duration to remove the trapped particulate matter, the method of removing the trapped particulate matter, and the temperature of removing the trapped particulate matter.

After the engine controller 429 increases the temperature of the diesel exhaust gas entering the reactive device 438 above the first minimum threshold, the temperature sensor 442 measures this increase in temperature and transmits a third alert signal to the engine controller 429. Upon receiving the first alert signal 432 from the pressures sensors 420,422 and the third alert signal from temperature sensor 442, the engine controller 429 transmits an ignite signal to the reactive device 438 to ignite the injected fuel within the diesel engine exhaust to increase the temperature of diesel engine exhaust passing through an outlet of the reactive device 438 and into an inlet of the diesel particulate filter 414. Although the system 410 involves the engine controller 429 increasing the temperature of the diesel exhaust gas entering the reactive device 438 by increasing the load on the engine 411 and injecting fuel within the diesel exhaust gas, the system may feature the engine controller 429 increasing the temperature of the diesel exhaust gas without injecting fuel within the diesel exhaust gas. For example, with advanced fuel systems, such as common rail, it may be possible to change the injection strategy to introduce fuel into the exhaust or late burning. This may be done by injecting fuel late in the power stroke, which is known as post injection.

The reactive device 438 may be a catalyst device 438 and include an internal catalyst component which facilitates igniting the injected fuel of the diesel exhaust gas and increases the temperature of the diesel exhaust gas at a temperature lower than in an absence of the catalyst device 438. During the ignition of the injected fuel within the diesel exhaust gas, the temperature of the diesel exhaust gas entering the catalyst device 438 increases to a first high temperature threshold to facilitate oxidization of the trapped particulate matter within the diesel particulate filter 414. This oxidization of the trapped particulate matter within the diesel particulate filter 414 at the first high temperature threshold is known to one of skill in the art as active regeneration. The trapped particulate matter may include a carbon material which oxidizes at the first high temperature threshold. The temperature of the diesel exhaust gas may be initially increased to the first minimum threshold for ignition of the injected fuel within the diesel exhaust gas using methods other than those discussed above. Additionally, the temperature of the diesel exhaust gas may be increased to the first high temperature threshold using various methods other than the catalyst component, such as using a fuel burner device, for example. In an exemplary embodiment of the present invention, the first high temperature threshold may be approximately 550 degrees Celsius, the oxidization may occur within an approximate temperature range of 550-600 degrees Celsius and the catalyst may be formed from catalytic coating on ceramic, silicon carbide, mullite, metallic material, or any other relevant material or combination of materials. However, other first high temperature threshold values and oxidization temperature ranges are possible, based on various factors including the material used, the amount of particulate matter to be oxidized, and the time duration of the regeneration, for example. Those elements not discussed herein, are similar to those elements discussed in the previous embodiments, with four-hundred scale number reference notation, and require no further discussion herein.

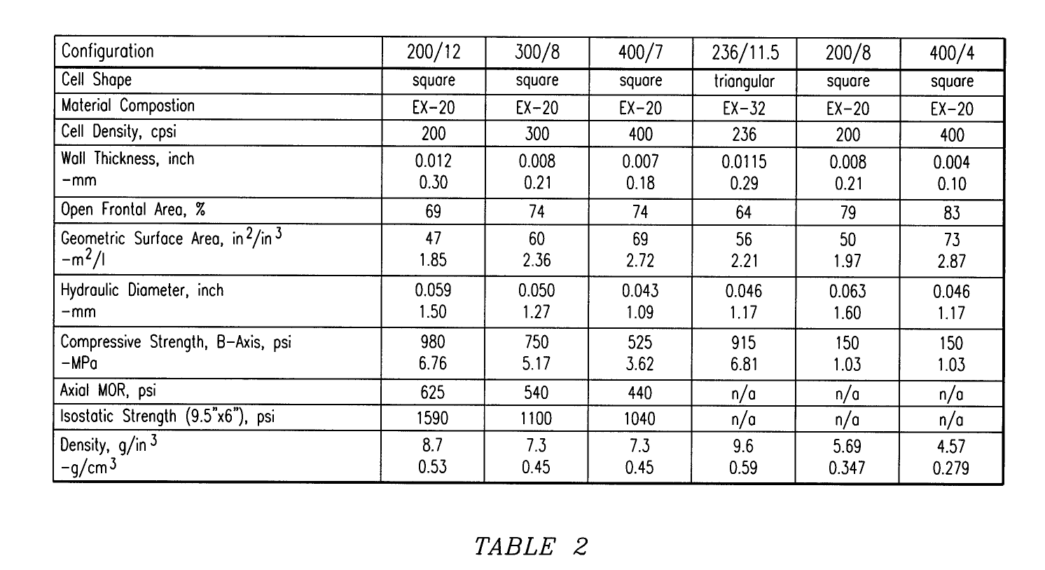

FIG. 6 illustrates an additional exemplary embodiment of a system 410′ of the present invention. Unlike the embodiment of the system 410 discussed above and illustrated in FIG. 5, in which active regeneration is used to oxidize trapped particulate matter from the diesel particulate filter, the system 410′ discloses a passive regeneration process to oxidize trapped particulate matter from the diesel particulate filter.

The system 410′ illustrated in FIG. 6 includes a turbocharger 450′ including an exhaust manifold to receive the diesel engine exhaust gas from the diesel engine 411′ and an outlet to output the diesel exhaust gas to the diesel particulate filter 414′. As discussed in the previous embodiment, the diesel particulate filter 414′ includes a plurality of diesel particulate filter units including a plurality of channels oriented parallel with the flow direction of the diesel engine exhaust. Additionally, a pair of pressures sensors 420′,422′ are positioned on opposing sides of the plurality of channels of the diesel particulate filter 414′. The pressure sensors 420′,422′ are configured to transmit the first alert signal 432′ to the engine controller 429′ upon measuring a pressure difference across the channels which exceeds a predetermined pressure threshold, as discussed in the previous embodiments.

As further illustrated in the exemplary embodiment of FIG. 6, a temperature sensor 442′ is coupled to the engine controller 429′ and positioned adjacent to the diesel particulate filter 414′ including the plurality of diesel particulate filter units. The temperature sensor 442′ is configured to determine the temperature of the diesel engine exhaust gas entering the diesel particulate filter 414′ including the plurality of particulate filter units. Additionally, the temperature sensor 442′ is further configured to transmit a second alert signal 445′ to the engine controller 429′ upon measuring a temperature lower than a second maximum threshold for the diesel particulate filter 414′. As discussed in further detail below, the second maximum threshold is the minimum temperature of the diesel exhaust gas at which the trapped particulate matter within the diesel particulate filter 414′ will oxidize in the presence of nitrous dioxide. The engine controller 429′ is configured to increase the temperature of the diesel exhaust gas entering the diesel particulate filter 414′ to the second maximum threshold upon the engine controller 429′ receiving the first alert signal 432′ and the second alert signal 445′.

To increase the temperature of the diesel exhaust gas entering the diesel particulate filter 414′, the engine controller 429′ is configured to transmit an increase signal 449′ to the diesel engine 411′ to increase an artificial load on the diesel engine to cause an increase in the temperature of the diesel engine exhaust gas entering the diesel particulate filter 414′. Alternatively, the engine controller 429′ is configured to electrically couple an alternator 456′ of the diesel engine 411′ to the turbocharger output to cause an increase in the temperature of the diesel engine exhaust gas entering the diesel particulate filter 414′. Although FIG. 6 illustrates the above-described arrangements to increase the temperature of the diesel exhaust gas, various other arrangements and methods may be utilized to increase the temperature of the diesel exhaust gas entering the diesel particulate filter. In an exemplary embodiment of the present invention, the second maximum threshold may be approximately 250 degrees Celsius and the oxidization in the presence of nitrous dioxide may occur in the approximate temperature range of 250-350 degrees Celsius. However, other second maximum threshold values and oxidization temperature ranges are possible, based on various factors including the material used, the amount of particulate matter to be oxidized, and the time duration of the regeneration, for example. Additionally, in the illustrated embodiment of FIG. 6, a nitrous dioxide filter 466′ is positioned upstream from the particulate filter 414′ to reduce the presence/concentration of nitrous dioxide in the diesel exhaust gas which enters the diesel particulate filter and optimize the passive regeneration process. However, the nitrous dioxide filter is not required and may be removed. Those elements not discussed herein, are similar to those elements discussed in the previous embodiments, with four-hundred prime scale number reference notation, and require no further discussion herein.

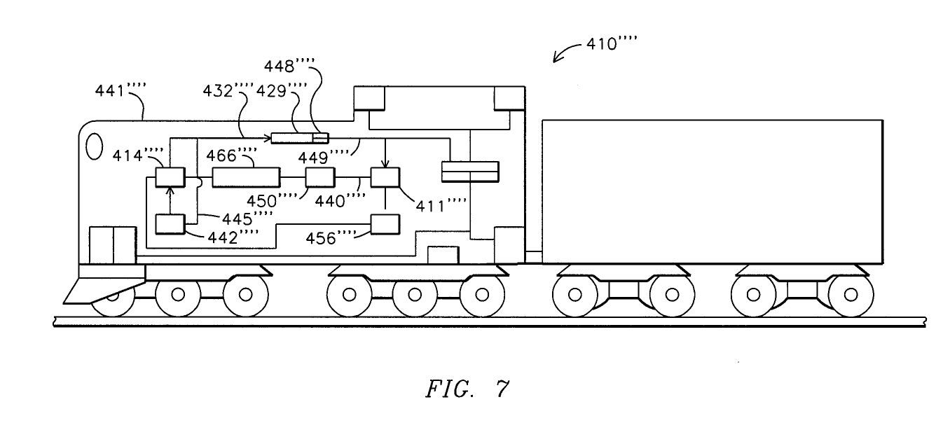

In an additional embodiment, a system 410″″ illustrated in FIG. 7 is provided for removing particulate matter from a particulate filter 414″″. The system 410″″ is similar to those embodiments discussed above, but does not include a pair of sensors to determine the extent of trapped particulate matter within the particulate filter 414″″. The system 410″″ includes an engine controller 429″″ coupled to the engine 411″″, where the engine controller 429″″ includes a memory 448″″ configured to store at least one loading rate of the plurality of diesel particulate filter 414″″ for a distance or time increment of the locomotive 441″″ traveling along a route 434″″. Upon the engine controller 429″″ having determined that a level of trapped particulate matter within the diesel particulate filter 414″″ exceeds a predetermined threshold, the engine controller 429″″ increases the temperature of the exhaust gas entering the particulate filter 414″″. The engine controller 429″″ calculates the level of trapped particulate matter based upon an initial level of trapped particulate matter, provided at an initial time during the locomotive trip, and at least one loading rate at one or more distance or time increments.

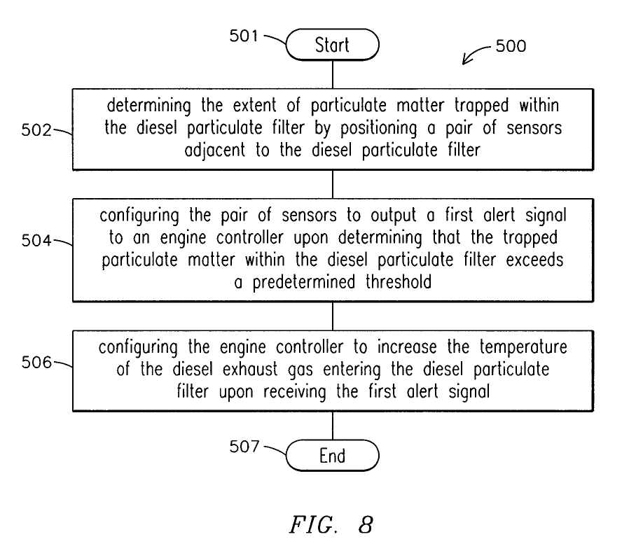

FIG. 8 illustrates an exemplary embodiment of a method 500 for removing particulate matter from a diesel particulate filter 414. The diesel particulate filter 414 includes a plurality of diesel particulate filter units to filter the particulate matter from diesel engine exhaust gas received from a diesel engine 411. The method 500 begins at block 501 by determining (block 502) the extent of particulate matter trapped within the diesel particulate filter 414 by positioning a pair of sensors 420,422 adjacent to the diesel particulate filter units of the diesel particulate filter 414. Alternatively, the engine controller 429 may monitor time or distance and estimate the extent of trapped particulate matter within the diesel particulate filter 414 based on stored loading rates for each time or distance increment along the locomotive route. The method 500 further includes configuring (block 504) the pair of sensors 420,422 to output a first alert signal 432 to an engine controller 429 upon determining that the trapped particulate matter within the diesel particulate filter 414 exceeds a predetermined threshold. The method 500 further includes configuring (block 506) the engine controller 429 to increase the temperature of the diesel exhaust gas entering the diesel particulate filter 414 upon receiving the first alert signal 432, before ending at 507.

Based on the foregoing specification, the above-discussed embodiments of the invention may be implemented using computer programming or engineering techniques including computer software, firmware, hardware or any combination or subset thereof, wherein the technical effect is to remove particulate matter from a diesel particulate filter. Any such resulting program, having computer-readable code means, may be embodied or provided within one or more computer-readable media, thereby making a computer program product, i.e., an article of manufacture, according to the discussed embodiments of the invention. The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will easily be able to combine the software created as described with appropriate general purpose or special purpose computer hardware, such as a microprocessor, to create a computer system or computer sub-system of the method embodiment of the invention. An apparatus for making, using or selling embodiments of the invention may be one or more processing systems including, but not limited to, a central processing unit (CPU), memory, storage devices, communication links and devices, servers, I/O devices, or any sub-components of one or more processing systems, including software, firmware, hardware or any combination or subset thereof, which embody those discussed embodiments the invention.

While the invention has been described in what is presently considered to be a preferred embodiment, many variations and modifications will become apparent to those skilled in the art. Accordingly, it is intended that the invention not be limited to the specific illustrative embodiment but be interpreted within the full spirit and scope of the appended claims.

What is claimed is:

1. A system for removing particulate matter from a particulate filter, said particulate filter comprising at least one particulate filter unit to filter said particulate matter from engine exhaust gas received from an internal combustion engine, said system comprising:
at least one sensor positioned adjacent to said at least one particulate filter unit, said at least one sensor configured to determine the extent of particulate matter trapped within said particulate filter unit; and
an engine controller coupled to said at least one sensor and said engine;
wherein said at least one sensor is configured to output a first alert signal to said engine controller upon said sensor having determined that said trapped particulate matter within said particulate filter unit exceeds a predetermined threshold, said engine controller is configured to increase the temperature of said exhaust gas entering said particulate filter upon receiving said first alert signal.

2. The system according to claim 1, further comprising:
a turbocharger including an exhaust manifold to receive said engine exhaust gas from said engine and further including an outlet to output said exhaust gas to said particulate filter;
an injector device positioned between said turbocharger and said particulate filter, said injector device configured to selectively inject an adjustable amount fuel into said engine exhaust gas exiting said outlet; and
a reactive device positioned between said injector device and said particulate filter, said reactive device configured to selectively ignite said adjustable amount of injected fuel within said engine exhaust gas upon entering an inlet of said reactive device to increase the temperature of said exhaust gas entering said particulate filter.

3. The system according to claim 2, further comprising:
a temperature sensor coupled to said engine controller and positioned adjacent to said reactive device, said temperature sensor being configured to determine the temperature of said engine exhaust gas entering said reactive device, said temperature sensor further configured to transmit a second alert signal to said engine controller upon measuring a temperature lower than a first minimum threshold for said reactive device to ignite said fuel;
wherein said engine controller is configured to increase the temperature of said exhaust gas entering said reactive device to above said first minimum threshold upon said engine controller receiving said first alert signal and said second alert signal.

4. The system according to claim 3, wherein said engine controller is configured to transmit a signal to the engine to change at least one of the speed and load on the engine, to cause an increase in the temperature of said engine exhaust gas entering said reactive device.

5. The system according to claim 3, wherein said engine controller is configured to transmit a signal to the engine to change a fuel injection schedule, to cause an increase in the temperature of said engine exhaust gas entering said reactive device.

6. The system according to claim 4, wherein upon said engine controller transmitting said signal to said engine, said temperature sensor is configured to transmit an overheat signal to said engine controller upon measuring the temperature of said engine exhaust gas exiting said particulate filter exceeding an overheat threshold, said engine controller configured to cause an increase in the load of said engine to increase the airflow through said particulate filter upon receiving said overheat signal.

7. The system according to claim 3, wherein said engine controller is configured to electrically couple an alternator of said engine to said turbocharger outlet to cause an increase in the temperature of said engine exhaust gas entering said reactive device.

8. The system according to claim 3,
wherein each particulate filter unit comprises a plurality of channels oriented parallel with the direction of said engine exhaust,
said at least one sensor is a pair of pressure sensors positioned on opposing sides of said plurality of channels of said particulate filter unit, said pressure sensors being configured to transmit said first alert signal to said engine controller upon measuring a pressure difference across one of said plurality of channels exceeding a predetermined pressure threshold.

9. The system according to claim 8, wherein said temperature sensor is configured to transmit a third alert signal to said engine controller upon measuring a temperature greater than said first minimum threshold; upon said engine controller receiving said first alert signal and said third alert signal, said engine controller is configured to transmit an ignite signal to said reactive device to ignite said injected fuel within said engine exhaust to increase the temperature of engine exhaust passing through an outlet of said reactive device and into an inlet of said particulate filter.

10. The system according to claim 9,
wherein said reactive device is a catalyst device including a catalyst component;
during said ignition of said injected fuel within said exhaust gas, the temperature of said engine exhaust entering said catalyst device is increased to a first high temperature threshold to facilitate oxidization of said trapped particulate matter within said at least one particulate filter unit, said trapped particulate matter comprising a carbon material to oxidize at said first high temperature threshold.

11. The system according to claim 9, wherein said catalyst device is configured to facilitate the chemical reaction of said injected fuel within said exhaust gas having a temperature above said first minimum threshold, said first minimum threshold being lower than a minimum temperature to ignite said fuel within said exhaust gas in the absence of said catalyst.

12. The system according to claim 2, wherein said reactive device is a fuel burner device.

13. The system according to claim 1, further comprising a turbocharger including an exhaust manifold to receive said engine exhaust gas from said engine and an outlet to output said exhaust gas to said particulate filter.

14. The system according to claim 13,
wherein each particulate filter unit comprises a plurality of channels oriented parallel with the direction of said engine exhaust;
said at least one sensor is a pair of pressure sensors positioned on opposing sides of said plurality of channels of said particulate filter unit, said pressure sensors being configured to transmit said first alert signal to said engine controller upon measuring a pressure difference across one of said plurality of channels exceeding a predetermined pressure threshold.

15. The system according to claim 14, further comprising a temperature sensor coupled to said engine controller and positioned adjacent to said at least one particulate filter unit, said temperature sensor being configured to determine the temperature of said engine exhaust gas entering said at least one particulate filter unit, said temperature sensor further configured to transmit a second alert signal to said engine controller upon measuring a temperature lower than a second maximum threshold for said particulate filter.

16. The system according to claim 15, wherein said engine controller is configured to increase the temperature of said exhaust gas entering said at least one particulate filter unit to said second maximum threshold upon said engine controller having received said first alert signal and said second alert signal.

17. The system according to claim 16, wherein said engine controller is configured to increase the temperature of said exhaust gas to said second maximum threshold to facilitate oxidization of said trapped particulate matter within said at least one particulate filter unit in the presence of nitrous dioxide.

18. The system according to claim 16, wherein said engine controller is configured to transmit an increase signal to the engine to increase an artificial load on the engine, to cause an increase in the temperature of said engine exhaust gas entering said at least one particulate filter unit.

19. The system according to claim 16, wherein said engine controller is configured to electrically couple an alternator of said engine to said turbocharger output to cause an increase in the temperature of said engine exhaust gas entering said at least one particulate filter unit.

20. The system according to claim 17, wherein said second maximum threshold is approximately 250 degrees Celsius and said oxidization in the presence of nitrous dioxide occurs in the approximate temperature range of 250-350 degrees Celsius.

21. The system according to claim 16, further comprising a nitrous dioxide filter positioned downstream from said at least one particulate filter unit to reduce the presence of nitrous dioxide in said exhaust gas entering said particulate filter.

22. A method for removing particulate matter from a particulate filter, said particulate filter comprising at least one particulate filter unit to filter said particulate matter from engine exhaust gas received from a engine, said method comprising:
determining the extent of particulate matter trapped within said particulate filter unit by positioning at least one sensor adjacent to said at least one particulate filter unit;
configuring said at least one sensor to output a first alert signal to an engine controller upon determining that said trapped particulate matter within said particulate filter unit exceeds a predetermined threshold; and
configuring said engine controller to increase the temperature of said exhaust gas entering said particulate filter upon receiving said first alert signal.

23. The method according to claim 22, further comprising:
providing a turbocharger to receive said engine exhaust gas;
selectively injecting an amount of fuel with an injector device into said engine exhaust gas exiting an output of said turbocharger; and
selectively igniting said amount of injected fuel within a reactive device, said injected fuel within said engine exhaust gas entering an inlet of said reactive device.

24. The method according to claim 23, further comprising:
coupling a temperature sensor to said engine controller; and
positioning said temperature sensor adjacent to said reactive device to determine the temperature of said engine exhaust gas;
said temperature sensor is configured to transmit a second alert signal to said engine controller upon measuring a temperature lower than a first minimum threshold, and said temperature sensor is configured to transmit a third alert signal to said engine controller upon measuring a temperature greater than said first minimum threshold.

25. The method according to claim 24, further comprising:
orienting a plurality of channels of said particulate filter unit parallel with the direction of the engine exhaust; and
positioning a pair of pressure sensors on opposing sides of at least one channel of said particulate filter unit;
said sensors to determine the pressure difference across a channel and to communicate said first alert signal to said engine controller when said measured pressure difference exceeds a predetermined pressure threshold.

26. The method according to claim 25, wherein upon said engine controller receiving said first alert signal and said third alert signal, said engine controller transmits an ignite signal to said reactive device to ignite said injected fuel within said engine exhaust to increase the temperature of engine exhaust passing through an outlet of said reactive device and into an inlet of said particulate filter.

27. The method according to claim 26,
wherein said reactive device is a catalyst device including a catalyst component;
during said ignition of said injected fuel within said exhaust gas, the temperature of said engine exhaust entering said catalyst device is increased to a first high temperature threshold to facilitate oxidization of said trapped particulate matter within said at least one particulate filter unit, said trapped particulate matter comprising a carbon material to oxidize at said high temperature threshold.

28. Computer readable media containing program instructions for removing particulate matter from a particulate filter, said particulate filter comprising at least one particulate filter unit to filter said particulate matter from engine exhaust gas received from a engine,
said computer readable media comprising a computer program code for configuring said engine controller to increase the temperature of said exhaust gas entering said particulate filter upon receiving said first alert signal.

29. The system according to claim 1, wherein said internal combustion engine is a diesel engine.

30. A system for removing particulate matter from a particulate filter, said particulate filter comprising at least one particulate filter unit to filter said particulate matter from engine exhaust gas received from an internal combustion engine, said system comprising:
an engine controller coupled to said engine; said engine controller including a memory configured to store at least one loading rate of said at least one diesel particulate filter unit for at least one of a distance or time increment of said locomotive traveling along a route; and
wherein upon said engine controller having determined that a level of trapped particulate matter within said at least one diesel particulate filter exceeds a predetermined threshold, said engine controller is configured to increase the temperature of said exhaust gas entering said particulate filter, said engine controller is configured to calculate said level of trapped particulate matter based upon an initial level of trapped particulate matter and said at least one loading rate at said at least one distance or time increment.
